(19) United States
(12) Patent Application Publication
(10) Pub. No.: US 2025/0296104 A1
(43) Pub. Date: Sep. 25, 2025

(54) TRIGGER SPRAYER

(71) Applicant: CANYON CORPORATION, Tokyo (JP)

(72) Inventor: Mitsuaki SHAZUKI, Sanyo Onoda-shi, Yamaguchi (JP)

(21) Appl. No.: 18/860,887

(22) PCT Filed: Apr. 25, 2023
(86) PCT No.: PCT/JP2023/016207

§ 371 Date: Oct. 28, 2024

(30) Foreign Application Priority Data
Apr. 29, 2022 (JP) 2022-075602

(51) Int. Cl. B05B 11/10

(52) U.S. Cl. CPC B05B 11/1011

(57) ABSTRACT

Trigger sprayer 100 comprises main body portion 1 having flow path 11, cylinder portion 13 formed in the flow path, and nozzle opening portion 12 located at a tip of the flow path; trigger portion 2 supported by support shaft portions 20 provided on both sides of the main body portion; piston portion 3 connected to the trigger portion; and spring portion 4 forcing the trigger portion forward. The piston portion slides along an inner wall of the cylinder portion based on the forward and rearward rotation of the trigger portion. Support hole portion 21 formed in the trigger portion to be attached to the support shaft portion has circular shape in side view. A cross section of the support shaft portion perpendicular to the axial direction is defected-circular shape, and a space is formed between a peripheral edge of the support hole portion and the support shaft portion.

### TECHNICAL FIELD

The present invention relates to a trigger sprayer and, in more detail, to a trigger sprayer that causes liquid to be sprayed or stops spraying the liquid by operating a trigger portion.

### BACKGROUND ART

A so-called sprayer is known that is attached to a container and sucks up the liquid contained in the container and sprays (atomizes) the liquid.

Among sprayers, a trigger sprayer, which is gripped by hand and operate a trigger portion to spray the liquid, is known.

Such trigger sprayer is widely used because it allows the liquid to be sprayed precisely onto a desired target object with a simple finger operation.

As such trigger sprayer, for example, a trigger sprayer is known in which liquid is sprayed from a nozzle, connected to a cylinder portion, by retracting and rotating the trigger portion and moving a piston portion to pressurize the liquid in the cylinder portion (for example, see PTL 1).

Also, a trigger sprayer is known in which a nozzle portion, a nozzle base portion attached to the nozzle portion, a piston portion attached to the nozzle base portion, a cylinder portion accommodating the piston portion, a body portion formed integrally with cylinder portion, a cover portion attached to the body portion, and a trigger portion pivotally attached to the body portion are provided, and the rotational movement of the trigger portion causes the piston portion to move via the nozzle base body and the liquid in the cylinder portion is pressurized, thereby the liquid is sprayed from the nozzle portion connected with the cylinder portion (for example, see PTL 2).

In these trigger sprayers, a through hole is formed near the upper end of the trigger portion, support shafts, cylindrical in side view, protrude from both side of the body portion, and the support shafts of the body portion is fitted to the through hole of the trigger portion, thereby the trigger portion is pivotally attached to the body portion.

### CITATION LIST

### Patent Literature

PTL 1: Japanese Patent Application Laid-Open No. 2015-136659
PTL 1: Japanese Patent Application Laid-Open No. 2015-137128

### SUMMARY OF INVENTION

### Technical Problem

However, conventional trigger sprayers, including the trigger sprayers described in PTL 1 and 2, have the disadvantage that the ease of rotation the trigger portion changes with fatigue and deterioration of their parts.

The present invention was made in view of the above circumstances, and the object of the present invention is to provide a trigger sprayer capable of maintaining the ease of rotation of the trigger portion for as long a period as possible.

### Solution to Problems

The present inventors have conducted extensive research and has found that the above-mentioned problem can be solved by forming a support shaft portion, provided in a main body portion, as a defected-circular shape in cross-sectional view, forming a support hole portion of a trigger portion as a circular shape in cross-sectional view, and forming a space between a peripheral edge of the assembled support hole portion and the support shaft portion, thereby the present invention is completed.

The present invention is a trigger sprayer for attaching to a container and spraying liquid in the container through a nozzle opening portion, comprising: a main body portion having a flow path for passing the liquid, a cylinder portion formed in the flow path, and the nozzle opening portion located at a tip of the flow path; a trigger portion supported by support shaft portions provided on both sides of the main body portion; a piston portion connected to the trigger portion; and a spring portion forcing the trigger portion forward to return the trigger portion to an original position, wherein the piston portion slides along an inner wall of the cylinder portion based on the forward and rearward rotation of the trigger portion around the support shaft portion, the support hole portion formed in the trigger portion to be attached to the support shaft portion has circular shape in side view, a cross section of the support shaft portion perpendicular to the axial direction is defected-circular shape, which is a shape in which an arch-shaped portion of at least a part of a circle is cut out, and a space is formed between a peripheral edge of the support hole portion and the support shaft portion.

In the trigger sprayer of the present invention, it is preferable that the cross section of the support shaft portion perpendicular to the axial direction is the defected-circular shape in which a first arch-shaped portion at a bottom portion of the circle and a second arch-shaped portion at a rear portion of the circle are cut out.

It is preferable that the trigger sprayer of the present invention is manufactured by injection molding, wherein an outer circumference of the cross section of the support shaft portion perpendicular to the axial direction has a straight first string portion formed by cutting-off of the first arch-shaped portion and a straight second string portion formed by cutting-off of the second arch-shaped portion, the first string portion is in horizontal direction, and the second string portion is in vertical direction.

In the trigger sprayer of the present invention, it is preferable that the outer circumference of the cross section of the support shaft portions perpendicular to the axial direction is formed by the first string portion, the second string portion, a large arch portion connecting the front end of the first string portion and the top end of the second string portion, and a small arch portion connecting the rear end of the first string portion and the bottom end of the second string portion.

In the trigger sprayer of the present invention, it is preferable that an angle between a center point of the support shaft portion and a straight line connecting both ends of the large arch portion is 160 to 220 degrees, and an angle between the center point of the support shaft portion and a straight line connecting both ends of the small arch portion is 2 to 5 degrees.

In the trigger sprayer of the present invention, it is preferable that the trigger sprayer further comprises a first valve portion which is stored in the cylinder portion and can open and close between the cylinder portion and the flow path, a second valve portion which is stored in a valve cylinder portion formed in the flow path and can open and close between the valve cylinder portion and the flow path, and a nozzle cap portion attached to the nozzle opening portion, wherein the valve cylinder portion is formed closer to the nozzle opening portion than the cylinder portion in the flow path.

### Advantageous Effects of Invention

In the trigger sprayer of the present invention, the liquid stored in the cylinder portion is pushed out by the piston portion and sprayed in conjunction with the rearward rotation of the trigger portion.

Besides, by forward rotation of the trigger portion which is returned by the spring portion, the liquid in the container is sucked up and stored in the cylinder portion in conjunction with this movement.

Thus, the liquid in the container can be repeatedly sprayed based on the rotation of the trigger portion.

Here, since the support hole portions formed in the trigger portion have circular shape in side view, a cross section of the support shaft portions perpendicular to the axial direction is defected-circular shape, and a space is formed between k a peripheral edge of the support hole portion and the support shaft portion, the contact area between the peripheral edge of the support hole portion and the support shaft portion can be made smaller.

In this way, since the part where the peripheral edge of the support hole portion and the support shaft portion contact and are worn and the part where its deterioration affects the rotation become smaller, compared to the case where there is no space between the peripheral edge of the support hole portion and the support shaft portion, the change of the rotatability of the trigger portion due to fatigue or deterioration of parts can be suppressed and the rotatability of the trigger part can be maintained as long as possible.

In the trigger sprayer of the present invention, since the cross section of the support shaft portions perpendicular to the axial direction is the defected-circular shape in which the first arch-shaped portion at the bottom portion of the circle and the second arch-shaped portion at the rear portion of the circle are cut out, the forward and upward load imparted on the support shaft portion when the trigger portion is pulled rearward can be relieved.

In the trigger sprayer of the present invention, since the first string portion is in horizontal direction and the second string portion is in vertical direction in the outer circumference of the cross section of the support shaft portion, the structure of the mold used for injection molding can be simplified.

In addition, the mold can be pulled out in a straight line along the first string portion or the second string portion after molding, thus the total number of molds required for molding can be reduced.

In the trigger sprayer of the present invention, since the outer circumference of the cross section of the support shaft portion perpendicular to the axial direction is formed by the large arch portion, the small arch portion, the first string portion and the second string portion, the part where the peripheral edge of the support hole portion and the support shaft portion contact is the large arch portion and the small arch portion, thereby axial runout of the trigger portion can be prevented from occurring.

Here, since the angle between the center point of the support shaft portion and the straight line connecting both ends of the large arch portion is 160 to 220 degrees, and the angle between the center point of the support shaft portion and the straight line connecting both ends of the small arch portion is 2 to 5 degrees, the ease of the rotation of the trigger portion and the stability of the rotation of the trigger portion can be sufficiently balanced.

In the trigger sprayer of the present invention, since the first valve portion is provided, the backflow of the liquid into the container can be prevented, and since the second valve portion is provided, pressure-accumulated liquid can be sprayed from the nozzle cap portion.

In the trigger sprayer of the present invention, since the nozzle cap portion is attached to the nozzle opening portion, the nozzle opening portion can be protected. In addition, since the function to open/close the flow path, adjust the spraying direction, etc. are provided to the nozzle cap portion, these functions can be provided to the trigger sprayer.

### BRIEF DESCRIPTION OF DRAWING

FIG. 1 is a side sectional view showing a trigger sprayer according to the present embodiment.

FIG. 2 is a side view showing assembling state of a main body portion of the trigger sprayer and a trigger portion according to the present embodiment.

FIG. 3 is a side view showing a support shaft portion of the trigger sprayer according to the present embodiment.

FIG. 4 is a schematic diagram showing mold opening step in the injection molding for manufacturing the main body portion of the trigger sprayer according to the present embodiment.

### DESCRIPTION OF EMBODIMENTS

In the following, with reference to the drawings as required, a preferred embodiment of the present invention is described in detail. Note in the drawings that the same components are provided with the same reference numeral and redundant description is omitted.

Also, relations in position such as above, below, left, and right are assumed to be based on the position relation depicted in the drawings unless otherwise specified.

Furthermore, the dimensional ratios of the drawings are not limited to the ratios depicted in the drawings.

The trigger sprayer of the present invention is used by attached to a container to spray a predetermined amount of liquid in the container from in a predetermined direction from a nozzle opening portion by operating a trigger portion.

Here, the shape and material of the container are not particularly limited, and any known shape and material can be adopted as appropriate.

In addition, the liquid is not limited as long as it can be sprayed, and any known liquid can be employed as appropriate.

Note that, in this specification, the downstream side is referred to as “front” and the upstream side as “back” in the direction in which the liquid is sprayed.

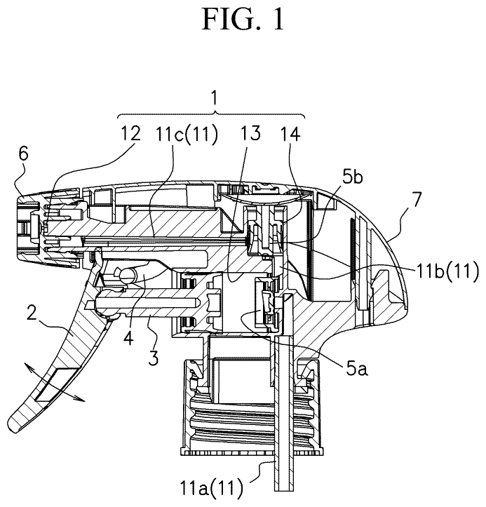

FIG. 1 is a side sectional view showing a trigger sprayer according to the present embodiment.

As shown in FIG. 1, the trigger sprayer 100 according to the present embodiment is provided with: a main body portion 1 having a flow path 11 for passing the liquid, a cylinder portion 13 and a valve cylinder portion 14 formed in the flow path 11, and the nozzle opening portion 12 located at a tip of the flow path 11; a trigger portion 2 supported by support shaft portions (not shown) provided on both sides of the main body portion 1; a piston portion 3 connected to the trigger portion 2; a spring portion 4 forcing the trigger portion 2 forward to return the trigger portion 2 to an original position; a first valve portion 5a which is stored in the cylinder portion 13 and can open and close between the cylinder portion 13 and the flow path 11; a second valve portion 5b which is stored in the valve cylinder portion 14 and can open and close between the valve cylinder portion 14 and the flow path 11; a nozzle cap portion 6 attached to the nozzle opening portion 12; and a cover portion 7 for covering the main body portion 1.

Thus, the trigger sprayer has a structure in which the main body portion 1, the trigger portion 2, the piston portion 3, the spring portion 4, the first valve portion 5a, the second valve portion 5b, the nozzle cap portion 6, and the cover portion 7 are assembled together.

Note that the valve cylinder portion 14 is formed closer to the nozzle opening portion 12 than the cylinder portion 13 in the flow path 11.

The flow path 11 contains a first flow path 11a, a second flow path 11b, and a third flow path 11c.

That is, the flow path 11 contains the first flow path 11a, from the container to the cylinder portion 13, the second flow path 11b from the cylinder portion 13 to the valve cylinder portion 14, and the third flow path 11c from the valve cylinder portion 14 to the nozzle opening portion 12.

In the trigger sprayer 100, it is preferable that the material of all of the main body portion 1, the trigger portion 2, the piston portion 3, the spring portion 4, the first valve portion 5a, the second valve portion 5b, the nozzle cap portion 6, and the cover portion 7 is resin. In this case, since metal is used as little as possible, the trigger sprayer 100 itself can be light weight. Specifically, it is preferable that the total weight of the trigger sprayer 100 is 20 g or less.

Among the resins, it is preferable that the material of these parts is polyolefin, and more preferable, polyethylene or polypropylene. In this case, it becomes possible to recycle these parts.

The trigger sprayer 100 is manufactured by injection molding, in which resin is injected into a mold. Injection molding is described below.

In the trigger sprayer 100, the piston portion 3 pivotally attached to the trigger portion 2 slides back and forth along the inner wall of the cylinder portion 13 by rotational movement of the trigger portion 2 in front and back direction around the support shaft portion (not shown).

In addition, the operation to rotate the trigger portion 2 rearward is performed by user, and the operation to rotate forward and return the trigger portion 2 is performed by the spring portion 4.

The attachment of the trigger portion 2 to the support shaft portion is described below.

In the trigger sprayer 100, by pulling the trigger portion 2 and rotating it backward, the piston portion 3 slides in the direction to pressurize inside the cylinder portion 13.

This causes the liquid in the cylinder portion 13 to flow out, and the resulting pressure causes the second valve portion 5b to open between the valve cylinder portion 14 and the second flow path 11b and the third flow path 11c, and the liquid flows through the third flow path 11c.

The liquid is then sprayed outward, through from the nozzle opening portion 12 to the nozzle cap portion 6.

On the other hand, when the pressurized state is resolved by the spraying of the liquid, the spraying of the liquid is stopped and the second valve portion 5b closes between the valve cylinder portion 14 and the second flow path 11b and the third flow path 11c.

The trigger portion 2 is then rotated and returned in the forward direction by the spring portion 4, and the piston portion 3 slides in the direction of depressurizing inside the cylinder portion 13.

The liquid in the container is then sucked up, and its pressure cause the first valve portion 5a to open between the cylinder portion 13 and the first flow path 11a, allowing the liquid to flow into the cylinder portion 13 until the depressurized condition inside the cylinder portion 13 is resolved.

According to the trigger sprayer 100 of the present embodiment, the liquid in the container can be repeatedly sprayed based on the rotation of the trigger portion 2.

In addition, since the first valve portion 5a is provided, the backflow of the liquid into the container can be prevented.

In addition, since the second valve portion 5b is provided, pressure-accumulated liquid can be sprayed from the nozzle cap portion 6.

In addition, since the nozzle cap portion 6 is attached, the nozzle opening portion 12 can be protected.

In addition, since the function to open/close the flow path, adjust the spraying direction, etc. are provided to the nozzle cap portion 6, these functions can be provided to the trigger sprayer 100.

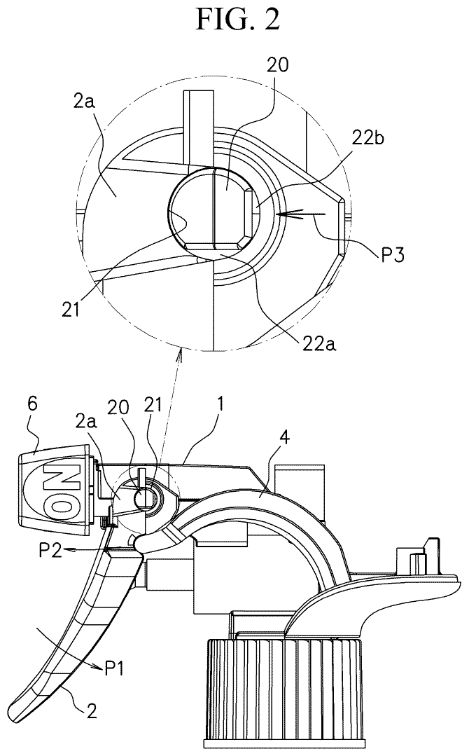

FIG. 2 is a side view showing assembling state of a main body portion of the trigger sprayer and a trigger portion according to the present embodiment.

As shown in FIG. 2, in the trigger sprayer 100 of the present embodiment, the upper end portion 2a of the trigger portion 2 is cut-off in a U-shape in front view, and the main body portion 1 is placed in the cut-off portion. That is, the upper end portion 2a of the trigger portion 2 sandwiches the main body portion 1 placed in the cut-off portion from both sides.

The upper end portion 2a on both sides of the trigger portion 2 are each provided with a support hole portion 21 for attaching to the support shaft portion 20 described below. The support hole portions 21 on the left and right sides have a plane-symmetrical structure.

Such support hole portion 21 is a circular-shaped hole in side view.

On the other hand, in the trigger sprayer 100, the support shaft portion 20 is provided as protruding outward on both sides of the main body portion 1. Further, the left and right support shaft portions 20 have a plane-symmetrical structure.

The support shaft portion 20 has defected-circular shape, at least a part of an arched portion of the circle is cut out. Specifically, the cross section of the support shaft portion 20 perpendicular to the axial direction is the defected-circular shape in which a first arch-shaped portion 22a at a bottom portion of the circle and a second arch-shaped portion 22b at a rear portion of the circle are cut out.

In the trigger sprayer 100, the cross-sectional size of the support hole portion 21 is the same as the cross-sectional size of the support shaft portion 20. Therefore, by attaching the support shaft portion 20 to the support hole portion 21, the trigger portion 2 is attached to the main body portion 1.

In this time, since the support shaft portion 20 is defected-circular shape in cross section, a space is formed between the support shaft portion 20 and the peripheral edge of the support hole portion 21 at the positions of the first arch-shaped portion 22a and the second arch-shaped portion 22b. This has the advantage that the support hole portion 21 can be easily attached to the support shaft portion 20.

In the trigger sprayer 100, since the space is formed, the contact area between the peripheral edge of the support hole portion 21 and the support shaft portion 20 can be made smaller than the conventional case in which the support shaft portion is circular shape in cross section (no space between them). As a result, since the part where the peripheral edge of the support hole portion 21 and the support shaft portion 20 contact and are worn and the part where its deterioration affects the rotation become smaller, the change of the rotatability of the trigger portion 2 due to fatigue or deterioration of parts can be suppressed and the rotatability of the trigger portion 2 can be maintained as long as possible.

In the trigger sprayer 100, as described above, when the user pulls the trigger portion 2 backward during spraying, the bottom portion of the trigger portion 2 is subjected to a force P1 in the backward direction, pulling the trigger portion 2, while the midportion of the trigger portion 2 is subjected to a force P2 in the forward direction by spring portion 4.

Then, since forces in opposite directions are exerted at the bottom portion and midportion of the trigger portion 2, the support shaft portion 20 is subjected to a force P3 in the backward direction from the peripheral edge of the support hole portion 21 of the trigger portion 2, while the contact portion between the trigger portion 2 and the spring portion 4 serves as the fulcrum.

In this time, in the trigger sprayer 100, since the space (the second arch-shaped portion 22b) is formed between the rear side of the support shaft portion 20 and the peripheral edge of the support hole portion 21, the forward load imparted on the support shaft portion 20 from the peripheral edge of the support hole portion 21 can be relieved.

Besides it, since the space (the first arch-shaped portion 22a) is also formed between the lower side of the support shaft portion 20 and the peripheral edge of the support hole portion 21, the upward load can also be relieved.

Incidentally, when returning the trigger portion forward, the user releases the trigger portion 2, so no force in the opposite direction is exerted and only the force of the spring portion 4 pushing the trigger portion 2 forward is exerted.

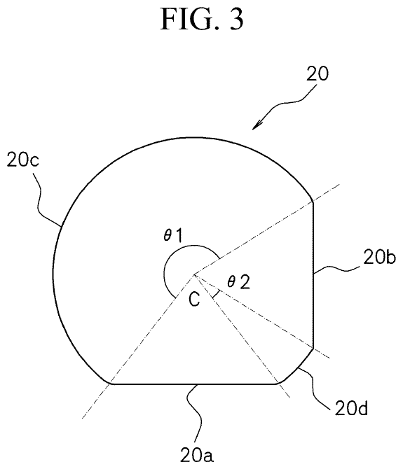

FIG. 3 is a side view showing a support shaft portion of the trigger sprayer according to the present embodiment.

As shown in FIG. 3, the outer circumference of the cross section of the support shaft portion 20 perpendicular to the axial direction is formed by a large arch portion 20c, a small arch portion 20d, a first string portion 20a and a second string portion 20b.

The first string portion 20a is a straight line formed by cutting-off of the first arch-shaped portion 22a, and is horizontal.

The second string portion 20b is a straight line formed by cutting-off of the second arch-shaped portion 22b, and is vertical. These can simplify injection molding.

Here, the injection molding of the main body portion 1 of the trigger sprayer 100 is performed in a known process. That is, for example, mold clamping step in which each mold is closed and held, injection step in which the mold is filled with resin, cooling step in which the resin is cooled, mold opening step in which the mold is opened, and ejection step in which the main body portion 1 is removed.

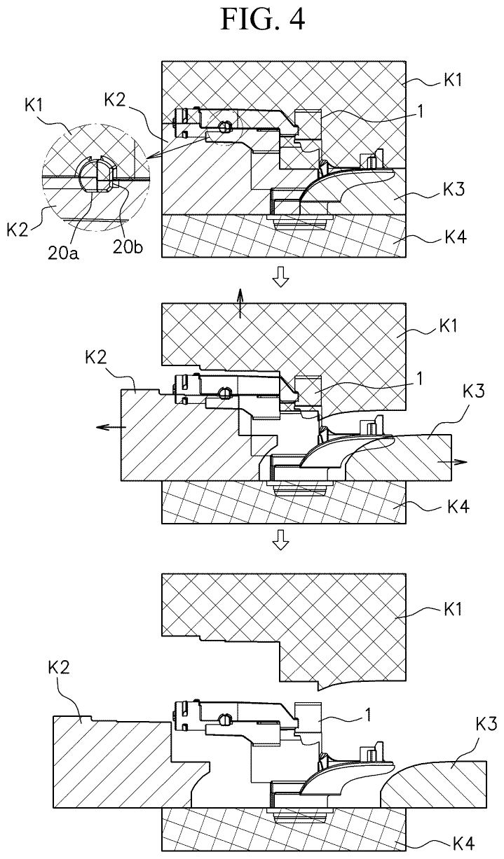

FIG. 4 is a schematic diagram showing mold opening step in the injection molding for manufacturing the main body portion of the trigger sprayer according to the present embodiment.

As shown in FIG. 4, in the injection molding of the main body portion 1, four separate molds are used: a first mold K1 for molding the upper portion of the main body portion 1 including the support shaft portion 20; a second mold K2 for molding the front portion of the main body portion 1 including the support shaft 20; a third mold K3 for molding the rear portion of the main body portion 1, and a fourth mold K4 for molding the lower portion of the main body portion 1.

In the mold opening step, since the second string portion 20b of the support shaft portion 20 is in vertical direction, the first mold K1 can be taken out vertically upward.

Similarly, since the first string portion 20a of the support shaft portion 20 is in horizontal direction, the second mold K2 to be taken out horizontally forward.

Thus, since there is no undercut section, the mold can be pulled out in a straight line along the first string portion 20a or the second string portion 20b after molding. This makes it possible to reduce the total number of molds required as much as possible.

Incidentally, if the support shaft portion 20 is circular in side view and does not have the first string portion 20a and the second string portion 20b, as in the conventional case, an undercut portion is created, which requires an additional mold, and the mold structure becomes also more complex.

Returning to FIG. 3, the large arch portion 20c is formed by a curve connecting the front end of the first string portion 20a and the top end of the second string portion 20b.

The small arch portion 20d is formed by a curve connecting the rear end of the first string portion 20a and the bottom end of the second string portion 20b.

The large arch portion 20c and the small arch portion 20d are located on the circumference of the same perfect circle, and they are independent of each other. The center point C of the perfect circle corresponds to the center of the support shaft portion 20.

Therefore, in the trigger sprayer 100, since the part where the support hole portion 21 and the support shaft portion 20 contact is at a position corresponding to the large arch portion 20c and the small arch portion 20d, the area subject to wear can be reduced and the axial shake of the trigger portion 2 can be also prevented.

Here, in the trigger sprayer 100 of the present invention, it is preferable that an angle θ1 between the center point C of the support shaft portion 20 and a straight line connecting both ends of the large arch portion 20c is 160 to 220 degrees.

If the angle θ1 is less than 160 degrees, the rotation of the trigger portion 2 may become unstable compared to the case where the angle θ1 is within the above range, and if the angle θ1 exceeds 220 degrees, the rotatability of the trigger portion 2 may easily change due to fatigue or deterioration of the parts compared to the case where the angle θ1 is within the above range and ease of rotation of the trigger portion 2 may be difficult to maintain.

In addition, in the trigger sprayer 100, the angle between the center point C of the support shaft portion 20 and a straight line connecting both ends of the small arch portion 20d is 2 to 5 degrees.

If the angle θ2 is less than 2 degrees, the vicinity of the small arch portion 20d of the support shaft portion 20 may be easily damaged during the rotation of the trigger portion 2 compared to the case where the angle θ2 is within the above range, and if the angle θ2 exceeds 5 degrees, the rotatability of the trigger portion 2 by the space may be disturbed compared to the case where the angle θ2 is within the above range.

Although the preferred embodiment of the present invention is described above, the present invention is not limited to the above embodiment.

In the trigger sprayer 100 of the present embodiment, although the main body portion 1, the trigger portion 2, the piston portion 3, the spring portion 4, the first valve portion 5a, the second valve portion 5b, the nozzle cap portion 6, and the cover portion 7 are separate parts and are assembled together, any of these parts may be molded together as a single unit.

In the trigger sprayer 100 of the present embodiment, although the cross section of the support shaft portion 20 perpendicular to the axial direction is the defected-circular shape in which a first arch-shaped portion 22a at a bottom portion of the circle and a second arch-shaped portion 22b at a rear portion of the circle are cut out, the number of arch-shaped portions to be cut out is not particularly limited.

That is, it may be one, three or more parts.

In addition, the size of the first arch-shaped portion 22a and the second arch-shaped portion 22b may be the same or different from each other.

In the trigger sprayer 100 of the present embodiment, although the outer circumference of the cross section of the support shaft portion 20 perpendicular to the axial direction is formed by the large arch portion 20c, the small arch portion 20d, the first string portion 20a and the second string portion 20b, this is not essential.

In the trigger sprayer 100 of the present embodiment, although the first string portion 20a is in horizontal direction and the second string portion 20b is in vertical direction, this is not essential.

For example, in injection molding, a draft angle may be provided to pull the mold out more smoothly.

That is, the first string portion 20a and the second string portion 20b may be slightly sloped, taking into consideration the draft.

### Industrial Applicability

The trigger sprayer of the present invention can be used as a device that sucks up liquid contained in a container, stores a certain amount of the liquid, and sprays it continuously.

According to the trigger sprayer of the present invention, the ease of rotation of the trigger portion can be maintained for as long a period as possible.

### Reference Signs List

1 . . . main body portion
100 . . . trigger sprayer
11 . . . flow path
12 . . . nozzle opening portion
13 . . . cylinder portion
14 . . . valve cylinder portion
2 . . . trigger portion
20 . . . support shaft portion
20a . . . first string portion
20b . . . second string portion
20c . . . large arch portion
20d . . . small arch portion
21 . . . support hole portion
22a . . . first arch-shaped portion
22b . . . second arch-shaped portion
2a . . . upper end portion
3 . . . piston portion
4 . . . spring portion
5a . . . first valve portion
5b . . . second valve portion
6 . . . nozzle cap portion
7 . . . cover portion
C . . . center point
K1 . . . first mold
K2 . . . second mold
K3 . . . third mold
K4 . . . fourth mold

1. A trigger sprayer for attaching to a container and spraying liquid in the container through a nozzle opening portion, comprising:
a main body portion having a flow path for passing the liquid, a cylinder portion formed in the flow path, and the nozzle opening portion located at a tip of the flow path;
a trigger portion supported by support shaft portions provided on both sides of the main body portion;
a piston portion connected to the trigger portion; and
a spring portion forcing the trigger portion forward to return the trigger portion to an original position, wherein the piston portion slides along an inner wall of the cylinder portion based on the forward and rearward rotation of the trigger portion around the support shaft portion,
a support hole portion formed in the trigger portion to be attached to the support shaft portion has circular shape in side view,
a cross section of the support shaft portion perpendicular to the axial direction is defected-circular shape, which is a shape in which an arch-shaped portion of at least a part of a circle is cut out, and
a space is formed between a peripheral edge of the support hole portion and the support shaft portion.

2. The trigger sprayer according to claim 1, wherein the cross section of the support shaft portion perpendicular to the axial direction is the defected-circular shape in which a first arch-shaped portion at a bottom portion of the circle and a second arch-shaped portion at a rear portion of the circle are cut out.

3. The trigger sprayer according to claim 2, wherein
the trigger sprayer is manufactured by injection molding,
an outer circumference of the cross section of the support shaft portion perpendicular to the axial direction has a straight first string portion formed by cutting-off of the first arch-shaped portion and a straight second string portion formed by cutting-off of the second arch-shaped portion, and
the first string portion is in horizontal direction, and the second string portion is in vertical direction.

4. The trigger sprayer according to claim 3, wherein the outer circumference of the cross section of the support shaft portions perpendicular to the axial direction is formed by the first string portion, the second string portion, a large arch portion connecting the front end of the first string portion and the top end of the second string portion, and a small arch portion connecting the rear end of the first string portion and the bottom end of the second string portion.

5. The trigger sprayer according to claim 4, wherein
an angle between a center point of the support shaft portion and a straight line connecting both ends of the large arch portion is 160 to 220 degrees, and
an angle between the center point of the support shaft portion and a straight line connecting both ends of the small arch portion is 2 to 5 degrees.

6. The trigger sprayer according to claim 1, wherein the trigger sprayer further comprises:
a first valve portion which is stored in the cylinder portion and can open and close between the cylinder portion and the flow path;
a second valve portion which is stored in a valve cylinder portion formed in the flow path and can open and close between the valve cylinder portion and the flow path; and
a nozzle cap portion attached to the nozzle opening portion, wherein the valve cylinder portion is formed closer to the nozzle opening portion than the cylinder portion in the flow path.

7. The trigger sprayer according to claim 2, wherein the trigger sprayer further comprises:
a first valve portion which is stored in the cylinder portion and can open and close between the cylinder portion and the flow path;
a second valve portion which is stored in a valve cylinder portion formed in the flow path and can open and close between the valve cylinder portion and the flow path; and
a nozzle cap portion attached to the nozzle opening portion, wherein the valve cylinder portion is formed closer to the nozzle opening portion than the cylinder portion in the flow path.

8. The trigger sprayer according to claim 3, wherein the trigger sprayer further comprises:
a first valve portion which is stored in the cylinder portion and can open and close between the cylinder portion and the flow path;
a second valve portion which is stored in a valve cylinder portion formed in the flow path and can open and close between the valve cylinder portion and the flow path; and
a nozzle cap portion attached to the nozzle opening portion, wherein the valve cylinder portion is formed closer to the nozzle opening portion than the cylinder portion in the flow path.

9. The trigger sprayer according to claim 4, wherein the trigger sprayer further comprises:
a first valve portion which is stored in the cylinder portion and can open and close between the cylinder portion and the flow path;
a second valve portion which is stored in a valve cylinder portion formed in the flow path and can open and close between the valve cylinder portion and the flow path; and
a nozzle cap portion attached to the nozzle opening portion, wherein the valve cylinder portion is formed closer to the nozzle opening portion than the cylinder portion in the flow path.

10. The trigger sprayer according to claim 5, wherein the trigger sprayer further comprises:
a first valve portion which is stored in the cylinder portion and can open and close between the cylinder portion and the flow path;
a second valve portion which is stored in a valve cylinder portion formed in the flow path and can open and close between the valve cylinder portion and the flow path; and
a nozzle cap portion attached to the nozzle opening portion, wherein the valve cylinder portion is formed closer to the nozzle opening portion than the cylinder portion in the flow path.
